(19) United States
(12) Patent Application Publication
(10) Pub. No.: US 2004/0181978 A1
(43) Pub. Date: Sep. 23, 2004

(54) Quick attachable blade

(76) Inventor: Darwin Robert Keiper, Pocono Lake, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/391,180

(22) Filed: Mar. 17, 2003

(51) Int. Cl. A01B 51/00

(52) U.S. Cl. 37/403

(57) ABSTRACT

A blade attachment that can be attached to an excavator or backhoe in 10 seconds and Removed in 3 seconds from the operators seat without the need of: tools, nuts, bolts, pins, chains, hoses or additional personnel. Said attachment is secured to the bucket by the means of two special u-shaped adaptors welded to the inside of the bucket. The blade having opposing brackets which support a grab bar and adjustable striker bar, allowing it to be installed on numerous buckets without modification of attachment or bucket allowing it to be removed quickly. The design of the bucket adaptors and striker bar allows it to be removed quickly. The design of the bucket adaptors and striker bar prohibits the blade from being removed during earth moving, and grading operations but allows the operator to maintain a level grade, when the machine is sitting on as much as a 10% grade difference. Said blade is of a size equal too 2 to 3 times the bucket width.

### CROSS-REFERENCE TO RELATED APPLICATIONS

| | | | |
|---|---|---|---|
| 6243975 | June, 2001 | Gall | 37/407 |
| 6098321 | August 2000 | Logan | 37/409 |
| 5253449 | October, 1993 | Webb/Pohl | 37/446 |
| 4189854 | February, 1980 | Haynes | 37/404 |
| 3942271 | March, 1976 | George | 37/404 |
| 3938680 | February, 1976 | Grimes | 414/722 |
| 6070345 | June, 2000 | Akaki, et al | 37/407 |
| 5918389 | June, 1999 | Hall | 37/407 |
| 4208815 | June, 1988 | Yunker, et al | 37/446 |
| 6088939 | July, 2000 | Logan | 37/468 |

### BACKGROUND OF THE INVENTION

This relation relates to earth moving equipment attachment specifically quick attachable grading blades for use with an excavator, or back hoe bucket, thereby transforming the digging bucket to a grading device and eliminating the expense of purchasing a grading machine such as a bulldozer costing up to $100,000 dollars. The quick attachable blade is a device that is worked by the excavator's bucket, dipper and boom rather than pushed by a tractor, so as not to cause ruts and excessive ground pressure. No matter what the ground condition wet, snow covered, or soft fill the job gets done. The quick attachable blade is the only blade that can be hooked up in 10 seconds and unhooked in 3 seconds bye the operators from his seat. No pins, chains, nuts, bolts, hydraulic lines, or additional labor is needed, therefore having a digging and trenching capability one second, and grading capability 10 seconds later. All without getting off of the machine.

With only one machine, to now do the job of two, the cost in labor, fuel and transpiration of a second machine is no longer necessary. The quick blade exclusive quick attachment allows you to keep the blade with the machine at all times.

Previous attempts have been made to make a quick attachable grading blade for a excavator that could be attached and removed without any, nuts, bolts, chains, hydraulic lines, or manual labor and as of this time none have been successful.

As shown by the previous art forms of Von Schalscha: Craig C. U.S. Pat. No. 5,596,825 an attempt has been made to simplify a grading device, making it quick detachable and inexpensive. This device may have met it's goal but requires, the operator to have to get out of the operating seat, have tools for the fasteners, or additional labor to complete the task, there by making this art, cumbersome, and time consuming for installation. Logan; John Duncan U.S. Pat. No. 6,088,939 addresses the quick alignment of tool and ease of removing the tool, but this too requires fasteners to secure tool to bucket. Requiring operators need to have tools to install fasteners, either forcing him to leave the operators seat or have additional labor. Therefore, this artwork again, does not address quick installation and removability from the operator's seat. Yunker et al. U.S. Pat. No. 4,208,815 has addressed a straight edge inserted over the teeth of the bucket for grading. While this too provides a grading blade, as in the previous art, it too requires, fasteners, tools for fasteners, the operator must leave his operating seat, and have additional labor to help with the installation.

### BRIEF SUMMARY OF THE INVENTION

This quick detachable grading device, which requires no tools, pins, bolts, chains, hydraulic lines or any other type of fasteners to install or remove at anytime, can be attached completely within ten seconds from the operators seat. Therefore, not requiring, fasteners, tools, additional labor, or operator to leave the seat of the equipment. This is made possible by specially designed adapters, which are welded on the inside of the backhoe or excavator bucket. The welding of the adapters are placed as to not disturb the normal everyday use of the bucket. Said attachment is designed with a grab bar, an adjustable striker plate, and adjustable moldboard for initial installation. After adjustments are completed, the striker plate and moldboard are welded into fixed position, which completes the initial installation. The blade attachment is now removable by rotating bucket upward which allows the bucket to slide off the grab bar, therefore disconnecting the attachment. To re-attach one slides the adapters over the grab bar rotating the bucket downward until contacting striker plate. The distance now from the grab bar to the striker plate is less than the length of the adapter slots. Therefore downward pressure on the bucket causes the adapter to hit the striker plate before grab bar can come out of adapter slots. This causes the attachment to stay on regardless of forward motion and downward pressure. The length of the adapter slots allow one side of the attachment to rise and hit the striker plate while other side remains in adapter slot creating a 10% variation in cutting edge surface to level grade. Thus accomplishing the ability to create a level grade when machine is out of level of up to a 10% grade. When attachment is crowed inward and bucket rotated to travel position, adapter slots prevent the attachment from falling off by hitting striker plate therefore eliminating additional binders, or chains on the machine for transporting.

### BRIEF DESCRIPTION OF THE SEVERAL VIEWS OF THE DRAWING

FIG. 1 Shows a quick attachment blade and mounting bracket in 3D

FIG. 2 Shows buckets with adapters installed and approaching quick attachment blade.

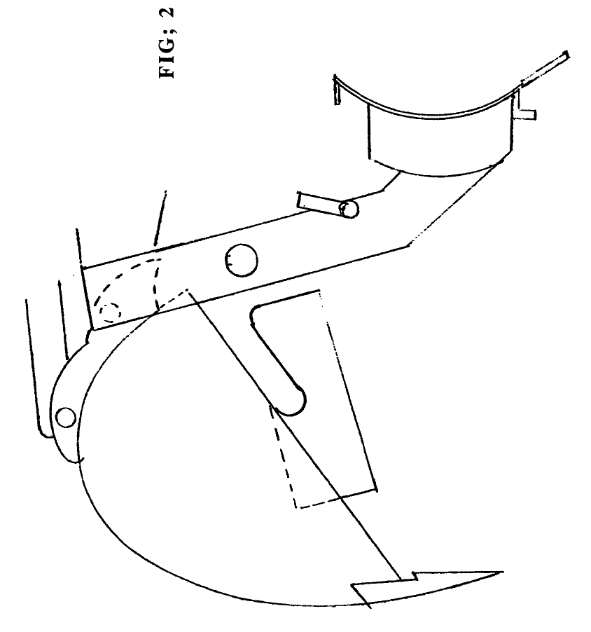

FIG. 3 Shows bucket with adapters installed sliding on the grab bar and in-between grab bar and striker plate.

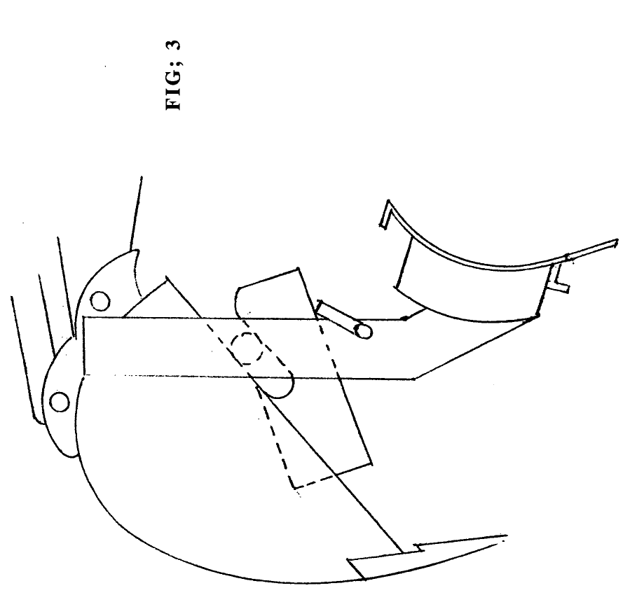

FIG. 4 Shows quick attach blade completely installed on bucket by means of rotating bucket causing adapters to pivot on grab bar and rotate till adapters hit striker plate thus completing installation.

### DETAILED DESCRIPTION OF THE INVENTION

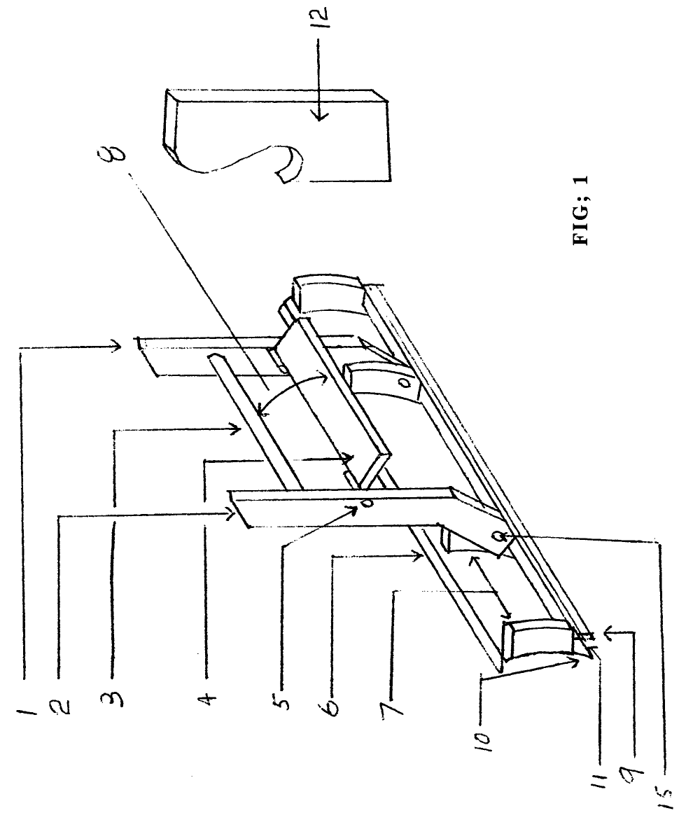

The upper portion of frame members 1&2 in FIG. 1 are connected by grab bar 3 in FIG. 1 which is permanently affixed. Then said adjustable striker plate 4 in FIG. 1 is affixed to upright frame 1&2 in FIG. 1 at a given measurement, from grab bar 3 in FIG. 1 by the means of a threaded rod 5 in FIG. 1. After adjustment of striker plate during initial installation adjusted striker plate is permanently a fixed by welding thus creating critical adapter slot travel confinement 8 in FIG. 1. At lower portion of frame members 1&2 in FIG. 1 adjustable moldboard 6 in FIG. 1 is connected by means of temporary pivot pins 15 in FIG. 1 to moldboard supports 7 in FIG. 1. Upon completion of adjustment during initial installation adjustable moldboard 6 in FIG. 1 is permanently a fixed to frame members 1&2 in FIG. 1 by the means of welding frame members to mold board support 7 in FIG. 1. Thus completing installation and adjustment of quick attachable blade.

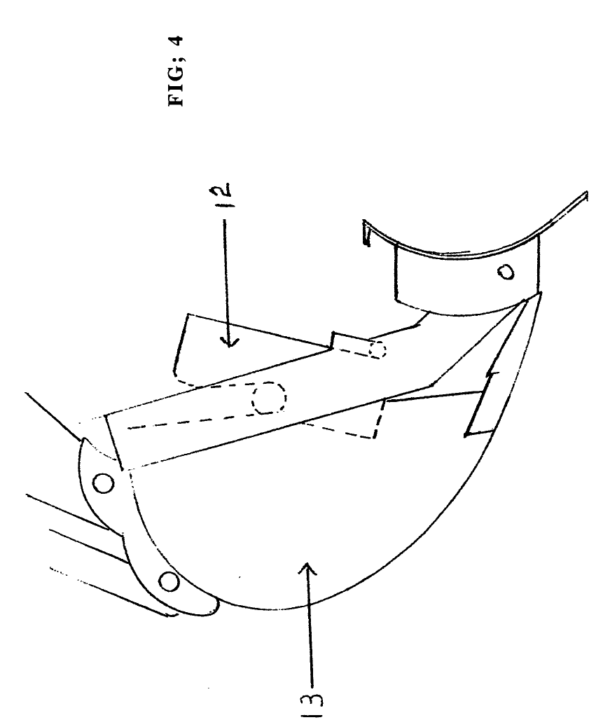

The attachment blade is affixed to backhoe bucket 13 in FIG. 4 by the means of adapter 12 in FIG. 4 which permanently attached to inside upper portion of bucket, so as not to disturb the normal everyday use of said bucket 13 in FIG. 4.

L bracket 9 in FIG. 1 attached to moldboard 6 in FIG. 1 and moldboard supports 7 in FIG. 1 create a location 11 in FIG. 1 for dirt to accumulate during fine grading, this creating a support of the entire blade which restricts unwanted elevations in final grade. By rotating the attachment creating L bracket 9 in FIG. 1 to rise and disperse said accumulated dirt and allowing cutting edge 10 in FIG. 1 to penetrate thus allowing cutting action of the dirt. L Bracket 9 in FIG. 1 also allows attachment to stand upright when disconnected making reattachment easy.

This quick attachable blade makes it more cost effective and more operator friendly then any past art. This quick attachable blade is designed to allow an operator to easily attach and detach all within 3-10 seconds without having to leave the operating seat, needing no fastening devices, fastening tools, or additional labor.

One of it's many uses during a normal operation of an excavator, is digging foundations. The quick attachable blade allows the operator to clean loosened material created by the teeth of the excavator from the bottom of an excavation, by rotating his bucket aligning with the grab bar thus attaching the blade all with in 3-10 seconds. Thus eliminating the need for handwork. This can be done immediately as the excavation becomes larger due to the quick ability to attach the blade throughout the completion of the whole excavation.

While using an excavator to load trucks from a stockpile the operator between loads can easily rotate his bucket forward causing the adapters to align with the grab bar thus attaching to the blade. This enables him to clean the work pad of all loose and fine debris and immediately counter rotate the bucket taking off the blade attachment without leaving the seat all with in 3-10 seconds.

The quick attachment blade makes it possible to utilize a grading blade in areas where using a bulldozer is not advisable, or not allowed. By being able to attach the quick blade in 3-10 seconds an operator can grade extremely wet soil, without creating, ruts, or undue pressure against newly poured foundation walls.

The quick blade attachment also has the ability to clean unwanted materials off of surfaces such as black top where a bulldozer or any other track machine could not go, by easily extending the boom on the excavator and using the blade to scrape the surface.

What is claimed at the invention is:

1. A quick attachable blade, comprising:
A. Adaptor plate meaning a flat plate with an elongated slot shaped like a U, cut out of the side creating a pocket so as to receive the grab bar.
B. Grab bar meaning a round bar of sufficient size as to fit adaptor plate and connect opposing frames.
C. Frame meaning two opposing flat plates in the upright position and supporting the grab bar and striker plate. Frames are made in a dog leg design having a pivot pin at the toe of the opposing legs to connect the grading blade.
D. Striker plate meaning a flat plate with two all thread rods fastened to opposite sends of said plate.
E. Grading blade-meaning plate formed to create a semi cup shaped blade said blade-having supports affixed to outer curve.
F. Said supports are formed in same cup shapes as the blade and has holes to except frame legs pivot pins which allows said blade to be adjustable said blade having a cutting edge bolted to it.

2. Said adaptor as in claim 1 being formed in a manner that prevents the blade from coming off by forcing the opposing grab bar in an upward motion causing striker plate to come into contact of said adaptors, therefore, preventing blade from disengaging.

3. Said adaptors as in claim 1 are designed in a manner that will allow as much as a 10% grade ability variation to the cutting edge in relation to any level working surface.

4. Said blade attachment in claim 1 requires no tools, pins, bolts, chains or hydraulic lines for attachment. The operator can install and remove the attachment from the operators seat without any additional personnel in as little as 10 seconds

5. Said attachment as in claim 1 is mounted to the excavator bucket by means of adaptors, fitted and welded as part of the initial installation on the opposing sides of said bucket and on the inside of said bucket leaving said bucket's cutting edge and teeth unobstructed and ready to perform normal working tasks.

6. Claim 1 having an adjustable striker plate which allows said blade to be installed on all proportionally sized buckets without modifications on said bucket or attachment. Once striker plate is adjusted to said bucket it is errantly welded in place as part of the initial installation.

7. Claim 1 having grab bar which allows said blade to be mounted on numerous proportionately sized buckets the means of the specialty designed adaptors in claim 1.
